(19) United States
(12) Patent Application Publication
(10) Pub. No.: US 2009/0184513 A1
(43) Pub. Date: Jul. 23, 2009

(54) PIPE FITTING ASSEMBLY AND A METHOD THEREFOR

(75) Inventor: Moty Avnon, Kibbutz Mashabay Sadeh (IL)

Correspondence Address: DEBORAH A. GADOR, P.O. BOX 4133, GANEL TIKVA, 55900, IL

(73) Assignee: SAGIV SHITUFIT CHAKLAIT BE'AM, KIBBUTZ MASHABAY SADEH (IL)

(21) Appl. No.: 12/374,309

(22) PCT Filed: Jul. 23, 2007
(86) PCT No.: PCT/IL07/00924

§ 371 Date: Jan. 18, 2009

(30) Foreign Application Priority Data
Jul. 23, 2006 (IL) 177035

(51) Int. Cl. F16L 55/00; F16L 21/02; B21D 51/16

(52) U.S. Cl. 285/24; 285/379; 29/890.141

(57) ABSTRACT

For use with a pipe fitting, an adapter including a hollow, substantially cylindrical sleeve formed of a polymeric material, preferably Nylon, the sleeve defining a bore on a first open end for engaging a pipe fitting and a tapered second open end for insertion into a pipe. A pipe fitting assembly is formed by the adapter together with a hollow fitting having a first open end defining an insert adapted and configured for insertion into the bore of the adapter; and a stop member; the adapter being adapted to abut against the stop member.

### FIELD OF THE INVENTION

The present invention relates to pipe fittings, in general and, in particular, to a pipe fitting assembly for coupling to multilayer plastic pipes.

### BACKGROUND OF THE INVENTION

Connecting two pipes together is a common need, both in industry and private homes. In the industrial field, connecting pipes is required in many different applications whereas, in private homes, the most common use is in plumbing. This invention relates to connecting plastic pipes, particularly PEX and PEX-Alu-PEX multilayer pipes, or pipes formed of similar materials, for flowing fluids, such as water. The term “pipe” will mean, wherever used in the description of the present invention, multilayer plastic pipes, as noted above.

Connecting two lengths of pipe cannot be accomplished directly. Pipe fittings are used to facilitate such connections. The connection of the pipes must be leak-free and stable under designated pressures. These requirements cannot be met without proper fittings, accessories and tools.

Several solutions for connecting a fitting to a pipe are known in the art. According to one solution, a metal insert is inserted into the pipe for rounding and slightly expanding the end of the pipe. This step permits greater ease of insertion of the insert into the pipe. However, this typically warps the end of the pipe, which remains warped throughout service. According to another solution, the end of the fitting is tapered. This tapered end has a slightly smaller diameter than that of the pipe to be connected to it, thus facilitating the insertion of the fitting into the pipe. When the tapered end of the fitting is inserted into the pipe and they are drawn together for making the connection, the pipe slightly expands as it slides along the tapered end of the fitting, so that, at the non-tapered portion of the fitting, the pipe tightly engages the fitting, thus sealing the connection.

Differences in expansion and contraction between the metal fitting and the plastic pipe under changing temperatures and pressures (defined by the thermal expansion co-efficient—CTE), can be problematic. The large difference in CTE between metals and plastics can cause the formation of a gap between the pipe and the fitting, often causing leakage. The known applications for connecting pipes and fittings do not provide satisfactory solutions to this problem.

A locking sleeve can be added over the connection. Tightening the sleeve, or crimping it, can apply extra pressure onto the connection, substantially improving sealing. Typically, with multilayer pipes, in order to achieve a suitable seal when connected to a fitting, a sealing member, typically an O-ring seal, is mounted on the fitting.

However, the known solutions are disadvantageous since the O-ring used for sealing the connection, which is invariably made of flexible materials, such as rubber and other elastomers, tends to tear or be distorted, or pulled out of grooves in which it is seated, because of the friction created between the inner walls of the pipe and the O-ring during the process of inserting the fitting in the pipe. The dislocation or distortion of this seal causes leakage in the connection, which must then be disconnected, have the O-ring replaced, and reconnected to re-form the seal.

Accordingly, there is a long felt need for a fitting assembly for connecting to plastic multilayer pipes that can be readily inserted into the pipe maintaining a seal between the pipe and the fitting assembly, and it would be very desirable to have such a fitting assembly that provides a thermally stable coupling, by both fitting and pipe having similar thermal expansion coefficients.

### SUMMARY OF THE INVENTION

The present invention relates to an adapter for a pipe fitting and a pipe fitting assembly with the adapter. The adapter includes a hollow, substantially cylindrical sleeve formed of a polymeric material, the sleeve defining a bore on a first open end for engaging a pipe fitting and a tapered second open end for insertion into a pipe. Preferably, the polymeric material is Nylon. Most preferably, the adapter further includes an internal shoulder to abut a pipe fitting for limiting insertion of the fitting into the adapter.

There is also provided according to the invention, a fitting assembly for a pipe, the fitting assembly including an adapter including a hollow, substantially cylindrical sleeve formed of a polymeric material, the sleeve defining a bore on a first open end for engaging a pipe fitting and a tapered second open end for insertion into a pipe, and a hollow fitting having a first open end defining an insert adapted and configured for insertion into the bore of the adapter, and a stop member, the adapter being adapted to abut against the stop member.

According to a preferred embodiment, the fitting assembly further includes a groove for receiving an annular seal, the adapter being arranged to cover the seal when mounted on the fitting.

According to an alternative embodiment, the fitting assembly further includes a locking sleeve for holding and reinforcing a pipe on the fitting assembly. Preferably, the insert of the fitting is adapted and configured for inserting in the bore and for sealing engagement therewith in the assembled state of the fitting assembly; and the sleeve is adapted and configured for being snugly mounted about the end of the pipe and fitting assembly.

There is also provided according to the present invention, a method for forming an adapter for a fitting assembly for a pipe, the method including forming, from a polymeric material, an adapter comprising a hollow, substantially cylindrical sleeve, defining a bore in a first open end of the adapter for engaging a pipe fitting; and tapering a second open end of the adapter for insertion into a pipe.

### BRIEF DESCRIPTION OF THE DRAWINGS

The present invention will be further understood and appreciated from the following detailed description taken in conjunction with the drawings in which:

FIG. 1 is an exploded sectional view of a pipe fitting assembly constructed and operative in accordance with one embodiment of the present invention;

FIG. 2 is a sectional view of the pipe fitting assembly of FIG. 1, as assembled; and

FIGS. 3a, 3b and 3c are partly cut-away side views of a pipe fitting assembly according to the invention, in various stages of coupling to a pipe.

### DETAILED DESCRIPTION OF THE INVENTION

The present invention relates to an adapter for a pipe fitting and a pipe fitting assembly for coupling multilayer plastic pipes, having a flexible polymeric, tapered or conical adapter mounted on a metal fitting. This permits easy insertion of the fitting assembly into a pipe to provide a substantially leak-free coupling. Since both adapter and pipe have substantially similar CTE's, thermal coupling is improved, thereby mitigating leakage. The fitting assembly according to the present invention facilitates connection of the fitting to the pipe, making the assembly process possible, even by a layman. The pipes described in this invention are multilayer pipes made of plastic, or of a similar material, most preferably PEX and Alu-PEX, while the fitting assembly typically includes a metal fitting with a flexible, polymeric adapter (for example, Nylon).

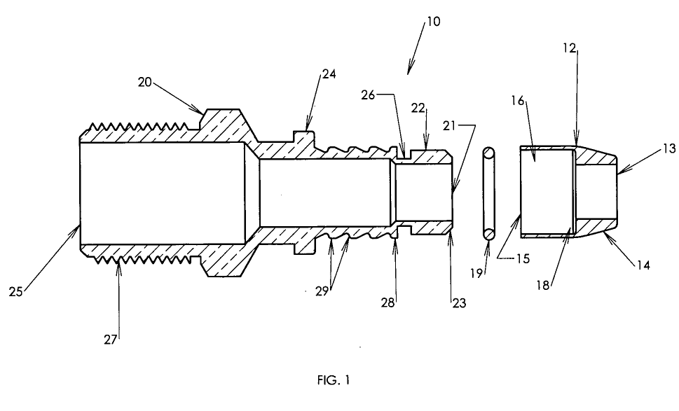

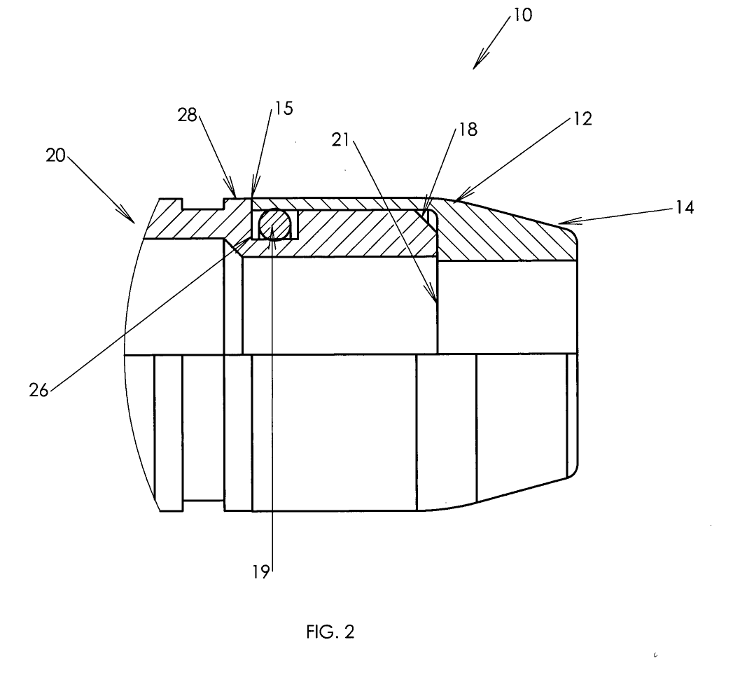

With reference to FIG. 1 and FIG. 2, there are shown sectional illustrations of a fitting assembly 10, constructed and operative in accordance with one embodiment of the invention, in exploded and assembled views, respectively. The fitting assembly 10 includes a hollow cylindrical metal fitting 20, and a tapered, hollow cylindrical plastic adapter 12. A flexible O-ring 19 (made of rubber or any other compatible elastomer) may be provided for improved sealing action.

Adapter 12 defines a tapered, substantially cylindrical sleeve defining an annular bore 16. Adapter 12 defines a first open end 13 having a tapered edge 14 and a second open end 15. Bore 16 is adapted and configured to receive and tightly engage an end of a fitting, such as fitting 20, described below. The length of tapered edge 14 may change from application to application. Adapter 12 is made of a material which is flexible enough to provide a seal, and yet firm enough to round and expand the end of the pipe when fitting assembly 10 is inserted into the pipe. Adapter 12 preferably is made of a resilient flexible plastic material (such as Nylon) having a CTE nearer to that of the fitted pipe (which is made of PEX or Alu-PEX-Alu) than does metal, so as to reduce CTE differences, thus improving thermal coupling between the fitted pipe and the fitting assembly and mitigating leakage. The outer surface of adapter 12 is smooth for reducing friction between the fitting assembly and the pipe upon insertion. An advantage of a Nylon adapter is that it has a slick surface which acts as a lubricant to further ease insertion of the fitting assembly into a pipe.

Fitting 20 includes at least two connecting open ends: a first end 21 defining an insert 22, which is adapted and configured for insertion into bore 16 of adapter 12, and a second end 25, defining a connecting portion 27 adapted and configured to connect to another pipe by the same arrangement of the present invention (not shown) or to an accessory, for example a faucet, by known arrangements, such as screw threads (not shown).

Fitting 20 further includes a protruding flange 24 acting as a stop member for the end of a pipe mounted thereon when fitting assembly 10 is coupled to a pipe. Fitting 20 also includes an annular groove 26 for receiving an annular seal 19. It will be appreciated that annular seal 19 seats substantially within groove 26, so seal 19 is protected by the adapter 12, when the fitting assembly is inserted into a pipe, as seen clearly in FIG. 2, illustrating the assembled state. It will be appreciated that the expansion of O-ring 19 (which is now pressed between internal walls of bore 16 and the bottom of groove 26) substantially prevents leakage between plastic adapter 12 and metal fitting 20. Fitting 20 also includes a stop member 28 disposed between the first and second ends against which adapter 12 abuts when mounted on insert 22. Preferably, fitting 20 includes a plurality of annular ridges 29 for tightly engaging the inside walls of the pipe mounted on the fitting and gripping the pipe to the fitting. Ridges 29 may be designed to cut into the innermost layer of the pipe, so as to enhance the seal and strengthen the connection.

Bore 16 of the adapter preferably defines an internal shoulder 18 adapted and configured to engage insert 22 of fitting 20 when inserted into bore 16. Preferably, insert 22 may include an annular beveled edge 23 for ease of coupling with adapter 12. Bore 16 is further adapted and configured for sealing engagement with insert 22 of fitting 20, and for its end 15 to abut flange 24 of fitting 20.

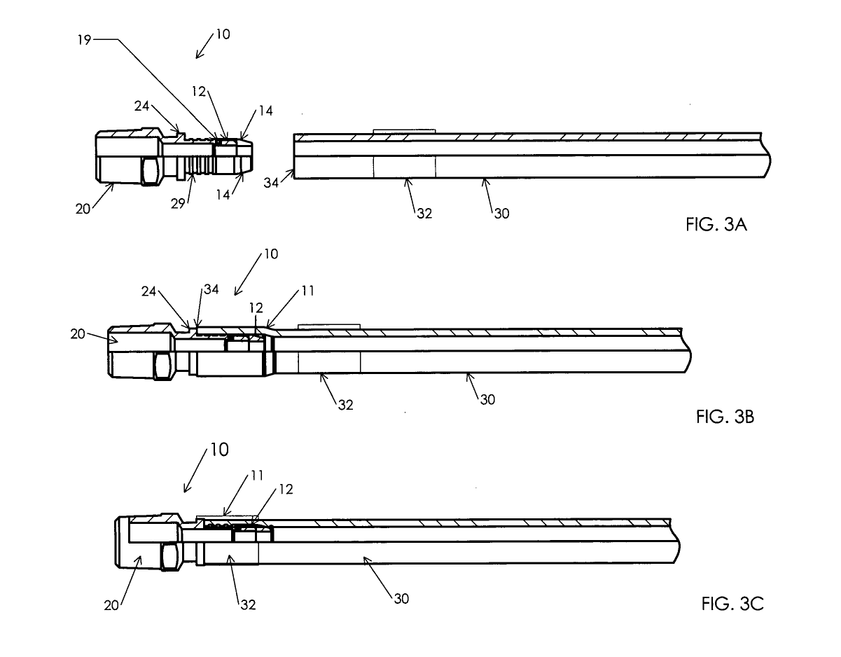

FIGS. 3a through 3c illustrate, in partly cut-away side views, the process according to the present invention of coupling a pipe 30 to fitting assembly 10 (formed of metal fitting 20 and adapter 12). FIG. 3a shows the fitting assembly 10 and a multilayer pipe 30, before the pipe is mounted on the fitting assembly. A locking sleeve 32 has been slidingly mounted on pipe 30.

In FIG. 3b, adapter 12 on fitting assembly 10 has been inserted into pipe 30 (facilitated by tapered edge 14) until annular opening 34 abuts against flange 24. The tapered end 14 of adapter 12 expands the end of pipe 30 during the insertion process. It will be appreciated that O-ring 19 has been protected by adapter 12 from deformation or tearing during this insertion process. Since the adapter 12 is of a slightly larger diameter than that of the inner walls of pipe 30, the portion of pipe 30 about the adapter is slightly stretched or expanded, producing an area 11 of thinner pipe wall engaging the fitting.

Finally, there is shown in FIG. 3c, that a locking sleeve 32 has been slidingly moved over thinner pipe wall area 11 to reinforce this area. Flange 24 may also serve as a stop member for sleeve 32, if desired. If desired, sleeve 32 can be tightened or crimped to apply additional pressure about thinner area 11. The applied pressure causes a closer engagement between the inner walls of pipe 30 and the fitting assembly, enhancing the seal. Furthermore, the applied pressure also urges the inner walls of pipe 30 to engage ridges 29. It will be appreciated by those skilled in the art that, due to the flexible nature of pipe 30, it also fills the gaps between ridges 29 and improves gripping of the pipe and sealing of the connection. At the end of the connection process, the pipe is sealed and tightly connected to the fitting assembly. The process of inserting the fitting assembly requires relatively a small amount of force and can be performed manually.

In an alternative embodiment of the invention, the multilayer pipe is flexible enough (e.g. PEX pipes without aluminum re-enforcement) to allow sealing without requiring the use of O-ring 19. For such a pipe, in fitting assembly 10, groove 26 is not required. The flexibility of the pipe allows the formation of a seal between the adapter, the metal fitting (particularly insert 22) and the pipe.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. For use with a pipe fitting assembly, an adapter
comprising:
a hollow, substantially cylindrical sleeve formed of a polymeric material;
said sleeve defining a bore on a first open end for engaging a pipe fitting assembly and a tapered second open end for insertion into a pipe;
said bore being sized and configured to permit said sleeve to slide over and cover the annular seal on the pipe fitting assembly, and create thermal coupling between said sleeve and said pipe and sealing engagement between said pipe fitting assembly and said pipe.

2. The adapter according to claim 1, wherein said polymeric material is Nylon.

3. The adapter according to claim 1, further including an internal shoulder to abut a pipe fitting for limiting insertion of said fitting into the adapter.

4. A fitting assembly for a pipe, the fitting assembly comprising:
an adapter comprising:
a hollow, substantially cylindrical sleeve formed of a polymeric material;
said sleeve defining a bore on a first open end for engaging a pipe fitting and a tapered second open end for insertion into a pipe; and a hollow fitting having
a first open end defining an insert adapted and configured for insertion into said bore of the adapter and a second open end;
an annular seal about said hollow fitting;
and a stop member;
said adapter being adapted to abut against said stop member;
said bore being sized and configured to permit said sleeve to slide over and cover the annular seal on the pipe fitting assembly, and create thermal coupling between said sleeve and said pipe, and sealing engagement between said pipe fitting assembly and said pipe.

5. The fitting assembly according to claim 4, further comprising a groove for receiving an annular seal, said adapter being arranged to cover said seal when mounted on said fitting.

6. The fitting assembly according to claim 4, further comprising a locking sleeve for holding and reinforcing a pipe on said fitting assembly.

7. The fitting assembly according to claim 6,
wherein said insert of said fitting is adapted and configured for inserting in said bore and for sealing engagement therewith in the assembled state of the fitting assembly; and
wherein said sleeve is adapted and configured for being snugly mounted about the end of the pipe and fitting assembly.

8. A fitting assembly according to claim 4, wherein said bore of said adapter further includes an internal shoulder for limiting said insert of said fitting.

9. A pipe fitting assembly according to claim 4, further including an annular groove for receiving said annular seal.

10. A pipe fitting assembly according to claim 1, wherein said fitting further includes a protruding flange disposed between said first and second open ends of said fitting, for abutting the end of the pipe.

11. A pipe fitting assembly according to claim 10, further comprising at least one annular ridge disposed between said stop member and said flange for gripping the pipe.

12. A method for forming an adapter for a fitting assembly for a pipe, the method comprising:
forming, from a polymeric material, an adapter comprising a hollow, substantially cylindrical sleeve;
defining a bore in a first open end of said adapter for engaging a pipe fitting assembly having an annular seal thereabout; and
tapering a second open end of said adapter for insertion into a pipe; and
sizing and configuring said bore to permit said sleeve to slide over and cover the annular seal on the pipe fitting assembly, and create thermal coupling between said sleeve and said pipe, and sealing engagement between said pipe fitting assembly and said pipe.

13. The method according to claim 12, wherein said step of forming an adapter comprises forming an adapter from Nylon.

14. The method according to claim 12, the method further comprising:
forming a hollow fitting having a first open end defining an insert adapted and configured for insertion into said bore of the adapter;
and forming a stop member on said hollow fitting;
said adapter being adapted to abut against said stop member.

15. The method according to claim 13, further comprising:
forming a hollow fitting having a first open end defining an insert adapted and configured for insertion into said bore of the adapter;
and forming a stop member on said hollow fitting;
said adapter being adapted to abut against said stop member.

16. The adapter according to claim 2, further including an internal shoulder to abut a pipe fitting for limiting insertion of said fitting into the adapter.

17. The fitting assembly according to claim 5, further comprising a locking sleeve for holding and reinforcing a pipe on said fitting assembly.

18. The fitting assembly according to claim 5, wherein said bore of said adapter further includes an internal shoulder for limiting said insert of said fitting.

19. The fitting assembly according to claim 6, wherein said bore of said adapter further includes an internal shoulder for limiting said insert of said fitting.

20. The pipe fitting assembly according to claim 4, wherein said fitting further includes a protruding flange disposed between said first and second open ends of said fitting, for abutting the end of the pipe.
